(19) United States
(12) Patent Application Publication
(10) Pub. No.: US 2019/0219883 A1
(43) Pub. Date: Jul. 18, 2019

(54) ELECTROCHROMIC MODULE AND DRIVING METHOD FOR ELECTROCHROMIC DEVICE

(71) Applicant: LG CHEM, LTD., Seoul (KR)

(72) Inventors: Ji Yeon KIM, Daejeon (KR); Dong Hyun LEE, Daejeon (KR); Jae Sung HAN, Daejeon (KR); Su Hee LEE, Daejeon (KR); Sa Rah KIM, Daejeon (KR); Doo Hoon SONG, Daejeon (KR)

(73) Assignee: LG CHEM, LTD., Seoul (KR)

(21) Appl. No.: 16/368,268

(22) Filed: Mar. 28, 2019

Related U.S. Application Data
(63) Continuation of application No. PCT/KR2017/010580, filed on Sep. 26, 2017.

(30) Foreign Application Priority Data
Sep. 29, 2016 (KR) 10-2016-0125275

(51) Int. Cl. G02F 1/163; G09G 3/19; G02F 1/155; G02F 1/1516; G02F 1/1524; G02F 1/1523

(52) U.S. Cl. CPC G02F 1/163; G09G 3/19; G02F 1/155; G02F 2001/1517; G02F 1/15245; G02F 1/1525; G02F 1/1516

(57) ABSTRACT

An electrochromic module and a driving method for an electrochromic are provided. The electrochromic module has an electrochromic device provided so as to be colored or bleached depending on an applied drive voltage, a sensing part for sensing an external temperature of the electrochromic device, a control part for determining an application time of a voltage satisfying a particular Relation Equation depending on the sensed external temperature, and a power supply part for applying a voltage to the electrochromic device by the determined application time.

### CROSS-REFERENCE TO RELATED APPLICATIONS

The present application claims is a By-pass Continuation Application of International Application No. PCT/KR2017/010580 filed on Sep. 26, 2017 which claims the benefit of priority based on Korean Patent Application No. 10-2016-0125275 filed on Sep. 29, 2016, the disclosures of which are incorporated herein by reference in their entireties.

### TECHNICAL FIELD

The present application relates to an electrochromic module and a driving method for an electrochromic device.

### BACKGROUND ART

The electrochromic device refers to a device using a characteristic that a color of an electrochromic material reversibly changes by an electrochemical oxidation/reduction reaction. The electrochromic device has a disadvantage that the response speed is slower than that of a conventional liquid crystal display or light emitting diode, but has advantages that a device having a large area can be manufactured with a small cost and power consumption is low, so that it can be applied to various fields such as smart windows, smart mirrors, and electronic papers.

On the other hand, the electrochromic device may have a structure in which an electrochromic layer comprising an electrochromic material is provided between electrode layers facing each other. When alternating reduction and oxidation potentials are applied to the electrode layer for a predetermined period of time, the device exhibits optical characteristic changes such as coloration or decoloration of the electrochromic layer as charge particles are inserted into or eliminated from the electrochromic material.

However, when excess electric charges are supplied to the electrochromic layer at a level higher than the level required for the optical characteristic change of the device for reasons such as application of a potential higher than a drive voltage or more increase of a voltage application time than necessary, durability of the device may be deteriorated while greatly increasing resistances of the electrochromic layer and the electrode layer or their interfaces. Therefore, it is necessary to control the device so that an appropriate charge amount can be supplied.

### DISCLOSURE

### Technical Problem

It is one object of the present application to provide an electrochromic device with improved durability and an electrochromic module comprising the same.

It is another object of the present application to provide a driving method for an electrochromic device capable of improving durability of the electrochromic device.

The above objects of the present application and other objects can be all achieved by the present application which is described in detail below.

### Technical Solution

In one example related to the present application, the present application relates to an electrochromic module. The electrochromic module of the present application can control an application time of a drive voltage to an electrochromic device according to an external temperature.

The electrochromic module comprises a temperature sensing part for sensing an external temperature of an electrochromic device. In the present application, the external temperature of the electrochromic device may mean a temperature of a portion other than the inside of the electrochromic device, for example, the periphery near the electrochromic device as the outside of the electrochromic device. The method for sensing the external temperature is not particularly limited. For example, the temperature may be directly measured by a temperature sensor included in the temperature sensing part, or the external temperature may be sensed through a method in which the external temperature measured through a separate device is input to or recorded in the temperature sensing part, or the like.

The electrochromic module comprises a control part for determining a voltage application time. The control part may control the application time of the drive voltage to the electrochromic device to satisfy a predetermined relationship according to the external temperature sensed by the temperature sensing part.

In the present application, the application time of the drive voltage is related to a charge amount supplied to the device. Specifically, as mentioned above, the excessive charge supply may degrade the durability of the device, and therefore it is necessary to supply an optimum reaction charge amount. Regarding the charge supply amount, a method of controlling the drive voltage may be considered, but the minimum reduction or oxidation potential is determined for each electrochromic material, and thus there is a limit to a method of controlling the charge amount by controlling the drive voltage itself. Accordingly, the inventors have confirmed that the charge amount supplied to the electrochromic layer changes according to the temperature, and have invented a electrochromic module capable of controlling the voltage application time depending on the external temperature such that charges as much as necessary for a color-switching reaction can be supplied without lowering the durability of the electrochromic device.

The control part can control the voltage application time so as to satisfy the following Relation Equation 1.

$$380.3 exp ( - \frac{x}{8.1} ) + 5.8 < y < - 0.24 exp ( \frac{x}{10.5} ) + 100.2 \qquad [ Relation Equation 1 ]$$

In Relation Equation 1 above, x is the sensed external temperature (° C.) and y means the voltage application time (sec). Relation Equation 1 above can be derived through modeling mentioned in the following embodiment.

The external temperature x may be in a range of −40° C. to 150° C. If the temperature is out of the above temperature range, Relation Equation 1 above cannot be satisfied, since normal driving of the device cannot be expected.

The y is a time for applying a supply voltage in the electrochromic device, which may mean each time for which the oxidation or reduction potential necessary for changing the electrochromic device following coloration to a bleached state or changing the electrochromic device following decoloration to a colored state is applied.

The electrochromic module comprises an electrochromic device. The electrochromic device may comprise an electrochromic layer, an electrolyte layer and an ion storage layer between two opposing electrode layers (first and second electrode layers).

The electrochromic layer and the ion storage layer may comprise electrochromic materials having complementary color-development characteristics to each other (a first electrochromic material in the electrochromic layer and a second electrochromic material in the ion storage layer). In the present application, the complementary color-development characteristic may mean a case where the second electrochromic material contained in the ion storage layer changes color by an oxidation reaction, when the first electrochromic material contained in the electrochromic layer changes color by a reduction reaction. Conversely, when the electrochromic layer comprises a first electrochromic material which changes color by the oxidation reaction, the ion storage layer may also comprise a second electrochromic material which changes color by the reduction reaction.

In one example, a reducing electrochromic material may be used as the first or second electrochromic material used in the electrochromic layer or the ion storage layer, respectively. As the reducing electrochromic material, an oxide of a transition metal may be used. More specifically, as the material, at least one of titanium oxide, vanadium oxide, niobium oxide, tantalum oxide, molybdenum oxide and tungsten oxide may be used, but the kind of the reducing electrochromic material is not particularly limited to the listed oxides.

In a further example, the first electrochromic material included in the electrochromic layer is Prussian blue, and the second electrochromic material included in the ion storage layer is tungsten oxide.

In another example, an oxidizing electrochromic material may be used as the first or second electrochromic material used in the electrochromic layer or the ion storage layer, respectively. As the oxidizing electrochromic material, at least one of Prussian blue (PB), cobalt oxide, ruthenium oxide, iridium oxide, nickel oxide, chromium oxide, manganese oxide and iron oxide may be used, but the kind of the oxidizing electrochromic material is not particularly limited to the listed materials.

The method for providing the electrochromic layer and/or the ion storage layer is not particularly limited. For example, known methods such as deposition or coating can be used. In one example, the electrochromic layer or the ion storage layer may be provided on the electrode layer using a spin coating method, a dip coating method, a screen printing method, a gravure coating method, a sol-gel method, or a slot die coating method.

In one example, when the electrochromic layer or the ion storage layer is provided through the coating method as set forth above, the first or second electrochromic material may be present in the form of particles in the electrochromic layer or the ion storage layer.

When the first or second electrochromic material has a particle shape, the particle-shaped electrochromic material may have a diameter of, for example, 200 nm or less. More specifically, the upper limit of the diameter of the particule-shaped electrochromic material may be 150 nm or less, 100 nm or less, or 50 nm or less, and the lower limit may be 10 nm or more. When the electrochromic material particle is not a spherical particle, the diameter may mean the largest length which is measured on any one dimension of the particle.

The electrolyte layer may be provided between the electrochromic layer and the ion storage layer. Through the electrolyte layer provided as above, electrolyte ions necessary for the oxidation or reduction reaction of the first and second electrochromic material can come and go between the electrochromic layer and the ion storage layer, whereby the electrolyte ions can participate in the oxidation or reduction reaction of the respective first and second electrochromic materials.

In one example, the electrochromic layer and/or the ion storage layer may have a thickness of, for example, 100 nm to 500 nm. If the thickness range is not satisfied, the charges necessary for color-switching reaction of the first or second electrochromic material may not be sufficiently inserted and the thickness may also act as an obstacle to insertion and/or elimination of the charges, so that it may be difficult to satisfy Relation Equation 1 above.

The electrolyte layer may comprise a liquid electrolyte, a polymer electrolyte or an inorganic solid electrolyte. The specific component constituting the electrolyte is not particularly limited, and for example, a material capable of providing an electrolyte ion such as Li⁺ can be appropriately selected.

The electrochromic module comprises a power supply part for applying a voltage to the electrochromic device by the determined application time. The method of electrically connecting the power supply part to the electrochromic device is not particularly limited. The magnitude of the drive voltage applied to the device by the power supply part can be controlled depending on the first and second electrochromic material included in the electrochromic layer and the ion storage layer. When the above-mentioned first and second electrochromic material are used, the drive voltage applied to the device by the power supply part may range from (±) 0.5 V to (±) 3.0 V.

According to another example of the present application, the present application relates to a method for driving an electrochromic device. The driving method for the electrochromic device of the present application can control the application time of the drive voltage to the electrochromic device depending on the external temperature, which can be achieved by using the electrochromic module as described above.

The electrochromic device in the driving method may comprise an electrochromic layer, an electrolyte layer and an ion storage layer between two opposing electrode layers, and the specific configurations and physical properties of each configuration are as mentioned above.

The driving method for the electrochromic device comprises a step of sensing an external temperature of the electrochromic device. The method of sensing the external temperature is not particularly limited, and the specific method or the range of the external temperatures is as mentioned above.

The driving method for the electrochromic device comprises a step of determining a voltage application time. The step of determining the application time may determine an application time of the drive voltage to the electrochromic device so as to satisfy Relation Equation 1 below depending on the sensed external temperature.

$$380.3 exp ( - \frac{x}{8.1} ) + 5.8 < y < - 0.24 exp ( \frac{x}{10.5} ) + 100.2 \qquad [ Relation Equation 1 ]$$

In Relation Equation 1 above, x is the sensed external temperature (° C.) and y means the voltage application time (sec). The specific meanings of the voltage application time and y are as mentioned above.

The driving method for the electrochromic device comprises a step of applying a voltage to the electrochromic device by a predetermined application time. The method of applying the voltage to the electrochromic device is not particularly limited, and for example, the electrochromic device and the power supply part for applying the supply voltage can be electrically connected, and the details of the power supply part are as mentioned above.

### Advantageous Effects

The present application can limit the supply of excess electric charges to the electrochromic layer or the ion storage layer by controlling the application time of the drive voltage to the electrochromic device depending on the temperature change in the outside of the electrochromic device Accordingly, the durability of the electrochromic device can be improved.

### BRIEF DESCRIPTION OF DRAWINGS

FIG. 1 is a schematic view of an electrochromic module according to an embodiment of the present disclosure.

FIG. 2 is a schematic view of an electrochromic device of the electrochromic module of FIG. 1.

FIGS. 3A and 3B are schematic views of the electrochromic layer and the ion storage layer, respectively, for the electrochromic device of FIG. 2.

FIG. 4 is a flow chart of a driving method for an electrochromic device according to an embodiment of the present disclosure.

FIG. 5 is a graph showing charge amount changes of Production Example 1 depending on temperatures.

FIG. 6 is a graph showing charge amount changes of Production Example 2 depending on temperatures.

FIG. 7 is a graph showing application times of a supply voltage in an electrochromic device depending on external temperatures.

FIG. 8 is a table showing Relation Equations of each curved line shown in FIG. 7

### MODE FOR INVENTION

The present disclosure will be more apparent from description of preferred embodiments of the present disclosure with reference to the accompanying drawings. The embodiments described herein are exemplary only for better understanding of the present disclosure, and it should be understood that the present disclosure may be implemented by making various modifications to the embodiments described herein. In addition, for better understanding of the present disclosure, in the attached drawings, instead of real scale, dimensions of some components may be exaggerated.

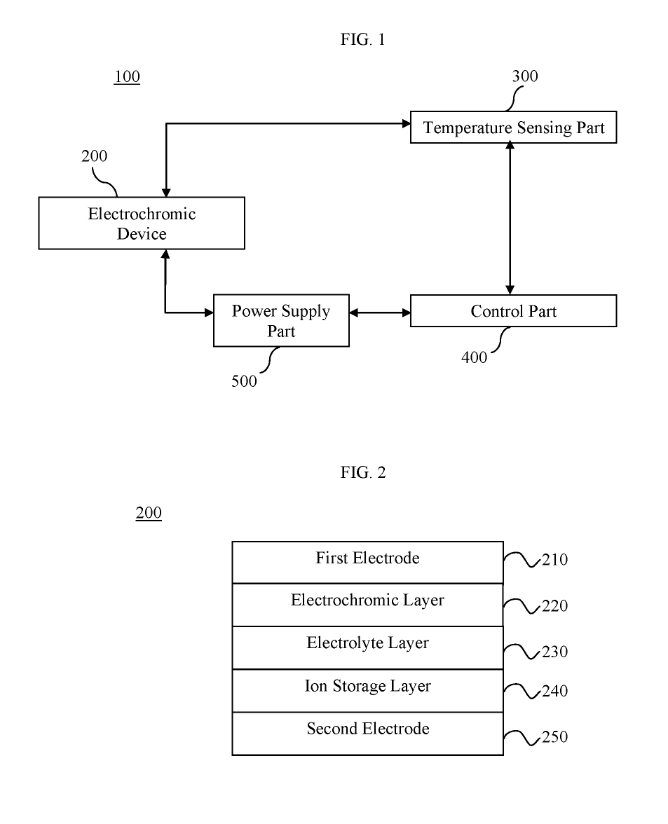

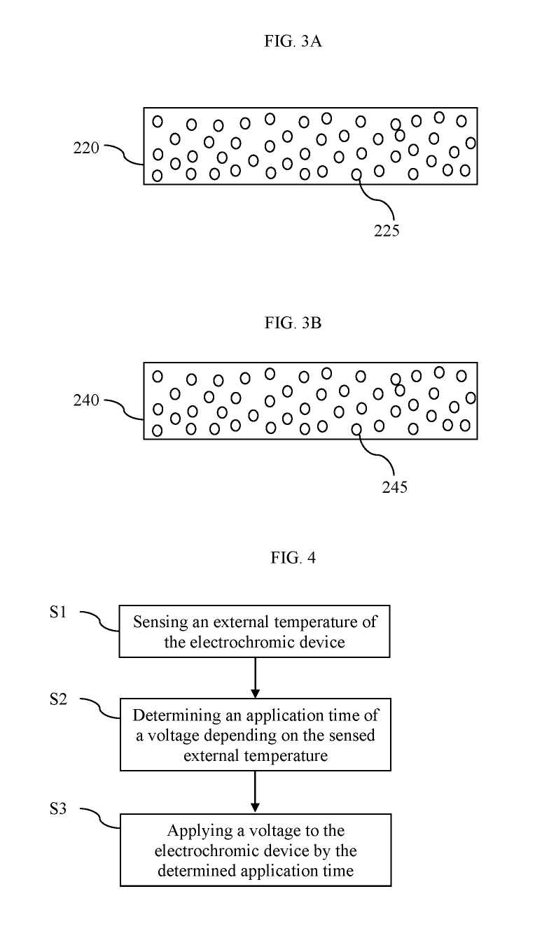

FIGS. 1 and 2 show an electrochromic module and an electrochromic device of the electrochromic module of the present disclosure. FIGS. 3A and 3B are schematic views of the electrochromic layer and the ion storage layer for the electrochromic device of FIG. 2

Referring to FIG. 1, an electrochromic module 100 includes an electrochromic device 200 which is provided so as to be colored or bleached depending on an applied drive voltage. The electrochromic module 100 also includes a temperature sensing part 300 for sensing an external temperature of the electrochromic device 200 and a control part 400 for determining an application time of a voltage that satisfies the Relation Equation 1 below depending on the sensed external temperature:

$$380.3 exp ( - \frac{x}{8.1} ) + 5.8 < y < - 0.24 exp ( \frac{x}{10.5} ) + 100.2 \qquad [ Relation Equation 1 ]$$

In Relation Equation 1 above, x is the sensed external temperature (° C.), and y is the application time (sec) of the drive voltage, where x is −40° C. to 150° C. The electrochromic device also includes a power supply part 500 for applying a voltage to the electrochromic device 200 by the determined application time.

Referring to FIG. 2, the electrochromic device 200 of the electrochromic module includes a first electrode 210, an electrochromic layer 220 comprising a first electrochromic material 225, an electrolyte layer 230, an ion storage layer 240 comprising a second electrochromic material 245 having a chromogenic characteristic complementary with the first electrochromic material 225 and a second electrode 250.

The first electrochromic layer 220 may include one of a reducing electrochromic material or an oxidizing electrochromic material and the second electrochromic layer 240 may include the other of the reducing electrochromic material or the oxidizing electrochromic material. For example, the reducing electrochromic material may be at least one of titanium oxide, vanadium oxide, niobium oxide, tantalum oxide, molybdenum oxide and tungsten oxide. The oxidizing electrochromic material may be at least one of Prussian blue, cobalt oxide, ruthenium oxide, iridium oxide, nickel oxide, chromium oxide, manganese oxide and iron oxide. In particular, the first electrochromic material 225 included in the electrochromic layer 220 may be Prussian blue and the second electrochromic material 245 included in the ion storage layer 240 may be tungsten oxide.

In this embodiment, the reducing electrochromic material and the oxidizing electrochromic material may have a diameter of 200 nm or less. In addition, the electrochromic layer 220 and the ion storage layer 240 have a thickness of 100 nm to 500 nm.

FIG. 4 is a flow chart of a driving method for an electrochromic device according to an embodiment of the present disclosure.

Referring to FIG. 4, a driving method for an electrochromic device 200 includes (S1) sensing an external temperature of the electrochromic device 200 and (S2) determining an application time of a voltage satisfying Relation Equation 1 below depending on the sensed external temperature:

$$380.3 exp ( - \frac{x}{8.1} ) + 5.8 < y < - 0.24 exp ( \frac{x}{10.5} ) + 100.2 \qquad [ Relation Equation 1 ]$$

In Relation Equation 1 above, x is the sensed external temperature (° C.), and y is the application time (sec) of the drive voltage, where x is −40° C. to 150° C. The driving method also includes (S3) applying a voltage to the electrochromic device by the determined application time.

The electrochromic device may have the particulars described above and are not repeated here.

Hereinafter, more particular examples of the electrochromic device and driving method will be described in. However, the scope of protection of the present disclosure is not limited by the examples described below.

### Production Example 1: Production of Electrode (Half-Cell)

A coating solution comprising tungsten oxide (WO₃) particles was applied to an Indium tin oxide/polyethylene terephthalate (ITO/PET) base material and heat-treated to form an electrochromic layer having a thickness of 300 nm. The coating solution was applied by a bar coating method and then heat-treated at 130° C. for 3 minutes. At this time, the area of the electrode was set to 20 cm² (4 cm×5 cm). When the produced half-cell is colored from a bleached state at a voltage of 0.7 V and room temperature (RT), light transmittance upon coloring may be changed to 70 to 80%.

### Production Example 2: Production of Counter Electrode (Half-Cell)

An electrode was produced in the same manner as in Production Example 1, except that an ion storage layer comprising PB particles was formed. When the produced half-cell is colored from a bleached state at a voltage of 0.7 V and room temperature (RT), light transmittance upon coloring may be changed to 70 to 80%.

Measurement of Optimum Reaction Charge Amount

When the voltage is continuously applied even after the color-switching of the electrochromic material is completed, an additional reaction and chemical degradation occur to decrease the durability of the electrochromic device, and thus, the charge amount supplied at the time when the color-switching is completed can be regarded as the optimum reaction charge amount. At this time, the time when the color-switching of the electrochromic material is completed may mean a time when 90% of the minimum light transmittance upon coloring is reached, if each half-cell as produced below is colored from a bleached state.

When the same voltage (0.7 V) was applied at room temperature (RT) to each of the half-cells of Production Example 1 and Production Example 2, the reaction charge amounts, which were changed depending on application times, were measured using Potentiostat. The measurement was performed after the coloring and bleaching of the device were repeated about 3 times to stabilize the coloring and bleaching degrees of the device, and the measured results are as shown in Table 1.

TABLE 1

| | | Time (sec) | | |
|---|---|---|---|---|
| | | 10 | 50 | 100 |
| Charge amount | Production Example 1 | 6 | 17 | 20 |
| (mC/cm²) | Production Example 2 | 6 | 11 | 15 |

In Table 1 above, it can be confirmed that when the external temperature and the applied voltage are the same, the reaction charge amount increases as the application time becomes longer.

In the case of Production Example 1, it could be confirmed that the color-switching of WO₃ was completed at 100 seconds (light transmittance: 67%), and the optimum reaction charge amount was a level of 20 mC/cm².

In the case of Production Example 2, it could be confirmed that the color-switching of PB was completed at 100 seconds (light transmittance: 67%), and the optimum reaction charge amount was a level of 15 mC/cm².

Measurement of Charge Amount Depending on Temperature Change

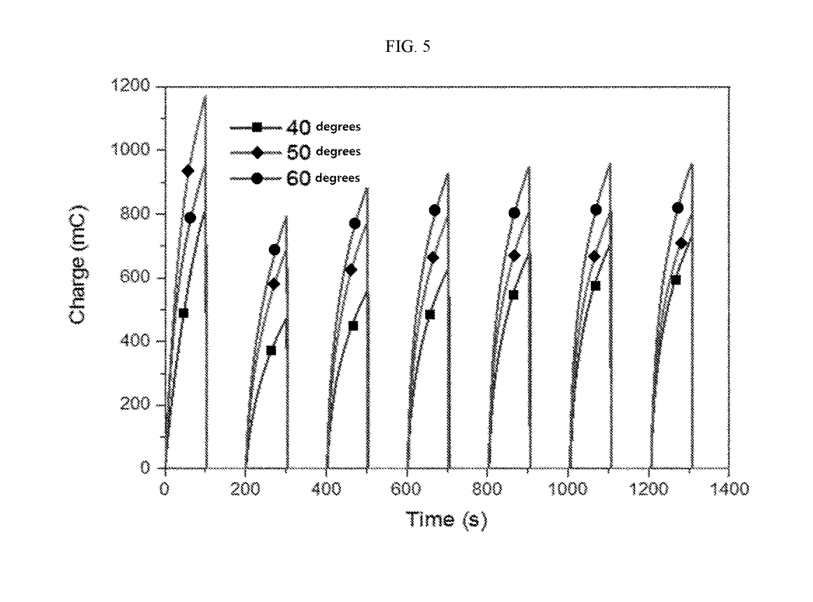

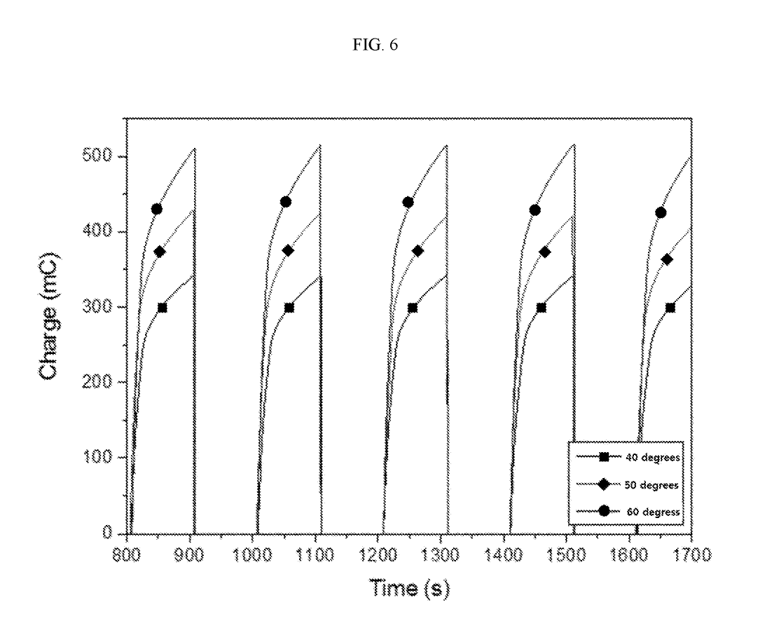

The reaction charge amounts at the external temperatures of 40° C., 50° C. and 60° C. were measured to compare times to reach the optimum charge amount. The results of Production Example 1 are as shown in FIG. 5 and the results of Production Example 2 are as shown in FIG. 6.

In the half-cell of Production Example 1, as compared with the times to reach a level of 20 mC/cm² which is the optimum reaction charge amount, it can be confirmed that the time to reach a level of 20 mC/cm² which is the optimum reaction charge amount becomes shorter as the temperature increases.

In the half-cell of Production Example 2, the times to reach a level of 15 mC/cm² which is the optimum reaction charge amount at the external temperatures of 40° C., 50° C. and 60° C. can be compared. It can be confirmed that the time to reach a level of 15 mC/cm² which is the optimum reaction charge amount becomes shorter as the temperature increases.

Graph Showing Application Times Depending on Temperature Changes and Derivation of Relation Equation 1

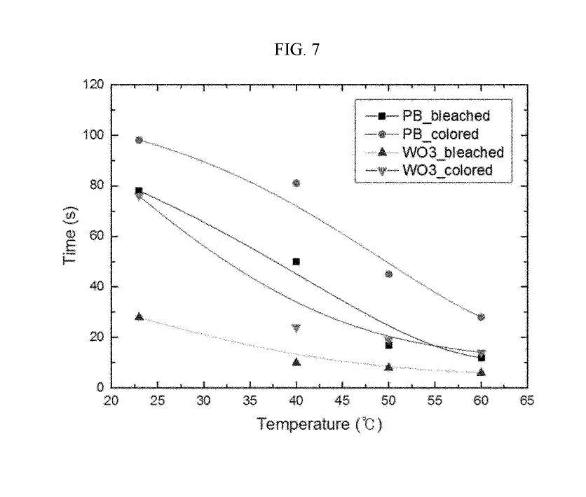

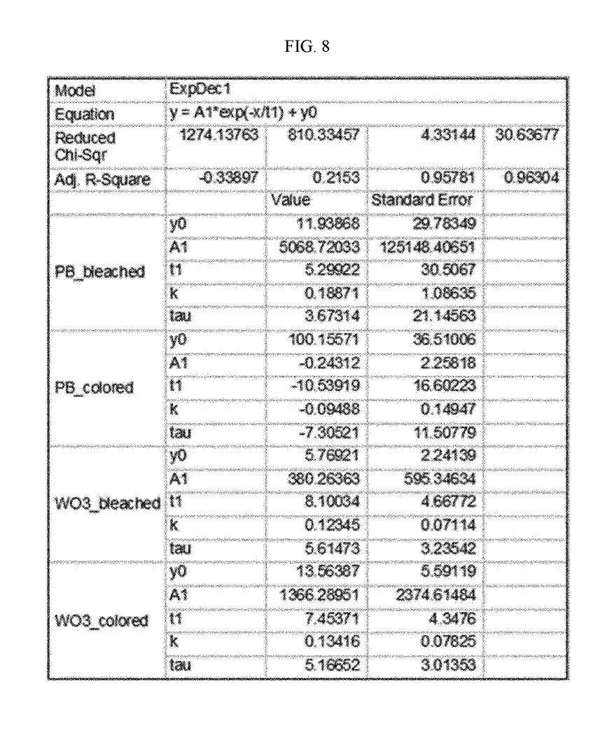

For the coloring-bleaching of WO₃ in Production Example 1 and the coloring-bleaching of PB in Production Example 2, the application times of the voltage depending on the external temperatures for supplying the optimum reaction charge amount were sensed and the results were shown in FIG. 7 and Relation Equation of each curved line are shown in FIG. 8 (using the origin program). Considering the region between the curved line according to the coloring of PB and the curved line according to the bleaching of WO₃ in FIG. 7 as a range of application times for supplying the optimum charge amount, Relation Equation 1 can be derived through FIG. 7.

$$380.3 exp ( - \frac{x}{8.1} ) + 5.8 < y < - 0.24 exp ( \frac{x}{10.5} ) + 100.2 \qquad [ Relation Equation 1 ]$$

In Relation Equation 1 above, x is the sensed external temperature (° C.) and y is the voltage application time (sec).

1. An electrochromic module comprising:
an electrochromic device provided so as to be colored or bleached depending on an applied drive voltage;
a temperature sensing part for sensing an external temperature of the electrochromic device;
a control part for determining an application time of a voltage satisfying Relation Equation 1 below depending on the sensed external temperature:
[Relation Equation 1]
$$380.3 exp ( - \frac{x}{8.1} ) + 5.8 < y < - 0.24 exp ( \frac{x}{10.5} ) + 100.2 \qquad [ Relation Equation 1 ]$$
wherein, x is the sensed external temperature (° C.), and y is the application time (sec) of the drive voltage, where x is −40° C. to 150° C.; and
a power supply part for applying a voltage to the electrochromic device by the determined application time.

2. The electrochromic module according to claim 1, wherein the electrochromic device comprises a first electrode, an electrochromic layer comprising a first electrochromic material, an electrolyte layer, an ion storage layer comprising a second electrochromic material having a chromogenic characteristic complementary with the first electrochromic material and a second electrode.

3. The electrochromic module according to claim 2, wherein the first electrochromic layer comprises one of a reducing electrochromic material or an oxidizing electrochromic material and the second electrochromic layer comprises the other of the reducing electrochromic material or the oxidizing electrochromic material.

4. The electrochromic module according to claim 3, wherein the reducing electrochromic material is at least one of titanium oxide, vanadium oxide, niobium oxide, tantalum oxide, molybdenum oxide and tungsten oxide.

5. The electrochromic module according to claim 3, wherein the oxidizing electrochromic material is at least one of Prussian blue, cobalt oxide, ruthenium oxide, iridium oxide, nickel oxide, chromium oxide, manganese oxide and iron oxide.

6. The electrochromic module according to claim 2, wherein the first electrochromic material included in the electrochromic layer is Prussian blue, and the second electrochromic material included in the ion storage layer is tungsten oxide.

7. The electrochromic module according to claim 3, wherein the reducing electrochromic material and the oxidizing electrochromic material have a diameter of 200 nm or less.

8. The electrochromic module according to claim 2, wherein the electrochromic layer and the ion storage layer have a thickness of 100 nm to 500 nm.

9. A driving method for an electrochromic device comprising:
sensing an external temperature of the electrochromic device;
determining an application time of a voltage satisfying Relation Equation 1 below depending on the sensed external temperature:
[Relation Equation 1]
$$380.3 exp ( - \frac{x}{8.1} ) + 5.8 < y < - 0.24 exp ( \frac{x}{10.5} ) + 100.2 \qquad [ Relation Equation 1 ]$$
wherein, x is the sensed external temperature (° C.), and y is the application time (sec) of the drive voltage, where x is −40° C. to 150° C.; and
applying a voltage to the electrochromic device by the determined application time.

10. The driving method for an electrochromic device according to claim 9, wherein the electrochromic device comprises a first electrode, an electrochromic layer comprising a first electrochromic material, an electrolyte layer, an ion storage layer comprising a second electrochromic material having a chromogenic characteristic complementary with the first electrochromic material and a second electrode.

11. The driving method for an electrochromic device according to claim 10, wherein the first electrochromic layer comprises a reducing electrochromic material or an oxidizing electrochromic material and the second electrochromic layer comprises the other of the reducing electrochromic material or the oxidizing electrochromic material.

12. The driving method for an electrochromic device according to claim 11, wherein the reducing electrochromic material is at least one of titanium oxide, vanadium oxide, niobium oxide, tantalum oxide, molybdenum oxide and tungsten oxide.

13. The driving method for an electrochromic device according to claim 11, wherein the oxidizing electrochromic material is at least one of Prussian blue, cobalt oxide, ruthenium oxide, iridium oxide, nickel oxide, chromium oxide, manganese oxide and iron oxide.

14. The driving method for an electrochromic device according to claim 10, wherein the first electrochromic material included in the electrochromic layer is Prussian blue, and the second electrochromic material included in the ion storage layer is tungsten oxide.

15. The driving method for an electrochromic device according to claim 11, wherein the reducing electrochromic material and the oxidizing electrochromic material have a diameter of 200 nm or less.

16. The driving method for an electrochromic device according to claim 10, wherein the electrochromic layer and the ion storage layer have a thickness of 100 nm to 500 nm.
